(19) United States
(12) Patent Application Publication
(10) Pub. No.: US 2010/0041383 A1
(43) Pub. Date: Feb. 18, 2010

(54) Cellular phone use limitation method

(76) Inventor: Scott A. Fournier, Portland, OR (US)

Correspondence Address: CHERNOFF, VILHAUER, MCCLUNG & STENZEL, LLP, 601 SW Second Avenue, Suite 1600, PORTLAND, OR, 97204-3157, US

(21) Appl. No.: 12/378,109

(22) Filed: Feb. 9, 2009

Related U.S. Application Data
(60) Provisional application No. 61/065,027, filed on Feb. 8, 2008.

(51) Int. Cl. H04M 3/00; H04W 4/00

(52) U.S. Cl. 455/418; 455/422.1

(57) ABSTRACT

A means of limiting the capability of a cellular telephone when said telephone is in motion is disclosed.

Applicant claims the benefit of provisional application No. 61/065,027, filed Feb. 9, 2008.

Cellular phone use has become pervasive. People frequently use cellular phones while driving. This is unsafe. Numerous studies have found that talking on a cell phone is a distraction to a driver which results in driving mistakes, traffic congestion, and unsafe behavior. This problem is exacerbated in a teen-aged driver, who faces a higher risk of death or injury due to driving errors and impaired judgment even without the added risks of cell phone use. Cell phone use is particularly dangerous in teen aged drivers, and many parents wish to restrict cell phone use by their driving children. Employers also may wish to restrict cell phone use by their driving employees as well in order to limit liability for accidents.

Many states have passed legislation requiring drivers to use hands free devices, but it is the conversation itself, not just the occupation of a hand, that impairs driving. It is likely that state or federal governments will act to restrict cell phone use with or without a hands free device, but such measures would face technological difficulties. Many cars now come equipped with blue tooth capabilities which enable drivers to talk on the phone without holding their phones to their ears or using a headset, making it impossible for law enforcement officers to determine that they are using their phones while driving. Any effective measure to limit cell phone use by drivers must employ technology which would disable a cellular phone, not enforcement by police officers who must visually ascertain that a driver is using a cell phone. Such technology should enable parents to prevent their children from using cell phones while driving even in the absence of legislative action.

Other references disclose devices built into cars which emit radiofrequencies when the car is in motion in order to disable cell phones. However, these devices must be built into cars at the time of manufacture, or else they will be vulnerable to tampering, and they cannot form the basis of a cell phone regulatory scheme because it would be impractical to require people to retrofit their cars with these devices and use them. Such devices are not helpful to parents who wish to control their children's cell phone use either. For example, a teenager whose parents wish to restrict cell phone use may borrow his father's car. His father will want to prevent his son from using a cell phone while driving but will not want to restrict his own cell phone use. A device which disabled all cell phone use in that vehicle would not solve this family's problem. What is needed is a means of limiting cell phone use by drivers which works within the phone or the cellular network, not the automobile.

Cell phones are always in communication with two or more base stations via control channels, and cellular networks include mobile telephone switching offices (MTSO) which keep track of the location of cellular phones so that they can route calls. Identifying information is transmitted via control channels so that the cellular network can find a recipient of a call. Communications between base stations and a cell phone are coordinated with the MTSO. Additionally, base stations can determine whether a cellular phone with which they are communicating is moving based on changes in signal strength because these base stations need to hand off calls to other base stations as a cell phone user travels between cells. Cell phone base stations can determine that a cellular phone within its cell is moving, and, together with the MTSO, control the functionality of that phone via signals transmitted via control channels.

As disclosed herein, cellular networks can be programmed to disable cellular phones which are moving or to cause cellular phones to disable themselves when they are moving. For example, a base station determines that a cellular phone is moving by evaluating changes in signal strength. The base station or the MTSO disables that phone so that no calls can be made or received by sending a signal to the phone via the control channel or other means that causes the phone to shut down or limits the functionality of the phone. Alternatively, the base station is programmed not to send or receive calls from a moving phone. When a base station determines that a phone is moving, it suspends service to that phone. Base stations may be programmed not to send or receive calls or other communications to or from any moving phone, or use of only specific phones may be limited. A particular user's phone might be designated by the cellular network as a phone that should not be used while in motion, and base stations may stop sending or receiving communications from that particular phone.

Alternatively, the above described functionality limitations may permit only calls to or from predetermined numbers, such as 911 or a parent's phone. Cell phone users or others, such as parents or employers, can use a web interface to a cellular network to change the phone numbers that are permitted while the phone is in motion, or temporarily suspend the motion limitations, for example when a child is about to take a journey by train. Certain functions may be disabled, such as texting or web surfing, or the phone could be completely disabled.

Other means of determining that the phone is in motion could be used, such as terrestrial or satellite triangulation. When either the phone or the network determines that the phone is moving, functionality can be restricted in response to that determination.

I claim:

1. A method of limiting cellular telephone use comprising:
a. providing a cellular telephone capable of transmitting to at least two cellular towers,
b. causing said cellular towers to determine whether said cellular phone is moving,
c. causing said cellular towers to transmit a signal to said telephone indicating movement, and
d. causing said cellular phone to disable itself in response to said signal.
